(19) United States
(12) Patent Application Publication
(10) Pub. No.: US 2026/0118593 A1
(43) Pub. Date: Apr. 30, 2026

(54) IN CABLE FIBER SHUFFLE

(71) Applicant: Microsoft Technology Licensing, LLC, Redmond, WA (US)

(72) Inventors: Jamie GAUDETTE, Winchester (GB); Yawei YIN, Redmond, WA (US); Binbin GUAN, Issaquah, WA (US)

(73) Assignee: Microsoft Technology Licensing, LLC, Redmond, WA (US)

(21) Appl. No.: 18/931,858

(22) Filed: Oct. 30, 2024

(51) Int. Cl. G02B 6/38; G02B 6/35; G02B 6/44

(52) U.S. Cl. CPC G02B 6/381; G02B 6/354; G02B 6/4401

(57) ABSTRACT

An in-cable fiber shuffle is described, the in-cable fiber shuffle having a first end and a second end. The in-cable fiber shuffle comprises a first plurality of optical fibers, each optical fiber comprising a continuous length of fiber from a first end to a second end. The in-cable fiber shuffle further comprises a first plurality of multi-fiber connectors at the first end of the in-cable fiber shuffle and a second plurality of multi-fiber connectors at the second end of the in-cable fiber shuffle. Each one of the first plurality of multi-fiber connectors are connected to the first ends of a different, non-overlapping subset of the first plurality of optical fibers and each optical fiber connected to a respective one of the first plurality of multi-fiber connectors is connected at its second end to a different one of the second plurality of multi-fiber connectors.

### BACKGROUND

There are many challenges of interconnecting servers within a data center. High data rates are required in order to transfer large volumes of data. This is often accomplished using high-radix routers, where the radix of a router refers to the number of ports or connections it has, e.g. how many other devices it can connect to directly. Use of high-radix designs reduces the number of hops that data must take between its source and destination and reduces the overall latency of the data center. However, this can lead to problems with cable management.

The embodiments described below are not limited to implementations which solve any or all of the disadvantages of known interconnects and methods of interconnecting switches within a data center.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

An in-cable fiber shuffle is described, the in-cable fiber shuffle having a first end and a second end. The in-cable fiber shuffle comprises a first plurality of optical fibers, each optical fiber comprising a continuous length of fiber from a first end to a second end. The in-cable fiber shuffle further comprises a first plurality of multi-fiber connectors at the first end of the in-cable fiber shuffle and a second plurality of multi-fiber connectors at the second end of the in-cable fiber shuffle. Each one of the first plurality of multi-fiber connectors are connected to the first ends of a different, non-overlapping subset of the first plurality of optical fibers and each optical fiber connected to a respective one of the first plurality of multi-fiber connectors is connected at its second end to a different one of the second plurality of multi-fiber connectors.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 shows a schematic diagram of a first example in-cable fiber shuffle;

FIG. 2 shows a schematic diagram of a second example in-cable fiber shuffle;

FIG. 3 is a graphical representation of in-cable fiber shuffle;

FIG. 4 shows a schematic diagram of an in-cable fiber shuffle installed in a data center; and

FIG. 5 shows a schematic diagram of two in-cable fiber shuffles installed in a data center.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples.

However, the same or equivalent functions and sequences may be accomplished by different examples.

Network configurations for data centers have been developed for cloud computing applications such as Infrastructure as a Service (IaaS) applications, Platform as a Service (PaaS) and Software as a Service (SaaS). These network configurations enable, in the case of IaaS, compute, storage and network resources to be provided on demand to data center tenants in a flexible manner. These requirements drive a need for flexible routing between switches in the data center, so that the data center can react to changing demands from tenants. Examples of data center topologies include fat-tree networks and dragonfly networks. These are both high-radix topologies which use high-radix routers, where the radix of a router refers to the number of ports or connections it has, e.g. how many other devices it can connect to directly. Use of high-radix designs reduces the number of hops that data must take between its source and destination and reduces the overall latency of the data center. The changing operating environment within a data center, as different amounts of data are routed to different destinations according to the needs of the tenants, leads to congestion at different points within the data center. This is managed by routing Application-Specific Integrated Circuits (ASICs) within the various switches in the data center which include large buffers and perform congestion control (e.g. by delaying transmission of packets where particular links within a data center are overloaded).

The requirements for a data center that is performing Artificial Intelligence (AI) training and inference tasks differs from other cloud computing services, such as IaaS. In particular, the Graphics Processing Units (GPUs) that are performing the AI tasks need to communicate in a very big cluster and so this requires a very high radix topology. Additionally, any packet congestion can cause tasks to fail, which necessitates the provisioning of very large buffers and/or a change in the architecture. Traffic flows are also very different as there is no virtualization (e.g. no combination of customers) as is the case in IaaS. The conventional network topologies require extensive use of patch panels and multiple cables to route connections through the data center; however, if used to implement the very high radix designs that are needed to perform AI tasks at scale (e.g. for Large Language Models with very large numbers of neurons), the volume of cables becomes physically too large to fit within the available space in a data center. Furthermore, each connection point introduces potential for signal degradation which cumulatively impacts data transmission quality and reliability.

Described herein is an in-cable fiber shuffle that can be used to interconnect switches within a data center. It is particularly suited to use in data centers that are performing AI tasks because it provides a low-loss, single-cable solution which reduces the number of connection points significantly as well as simplifying the physical layout, resulting in improved transmission quality and reliability and a more manageable network infrastructure (e.g. reducing the physical volume of cables that are required and simplifying installation and maintenance). Use of the in-cable fiber shuffle described herein additionally facilitates an increase in the radix of a data center in which it is used without requiring an increase in the number of ports on routers. This increases the size of AI cluster that can be used and provides a lower power solution.

The in-cable fiber shuffle comprises a plurality of optical fibers each comprising a continuous length of fiber from a first end to a second end, i.e. there are no splices in the length of fiber between the first and second ends of the fiber. As splices introduce losses, by avoiding the use of any splices the loss of the cable is reduced. The cable is terminated at each end by a plurality of multi-fiber connectors, such as Multi-fiber Termination Push-on (MTP®) connectors. Any multi-fiber connector type may be used (e.g. to be compatible with the data center switch ports to which they will be connected). The first ends of each of the plurality of optical fibers in the cable are terminated at a first end of the cable in a first plurality of multi-fiber connectors and the second ends of each of the plurality of optical fibers in the cable are terminated at a second end of the cable in a second plurality of multi-fiber connectors. At the first end of the cable, a different (non-overlapping) subset of the plurality of optical fibers is terminated (at their respective first ends) at each of the multi-fiber connectors of the first plurality of multi-fiber connectors. Similarly, at the second end of the cable, a different (non-overlapping) subset of the plurality of optical fibers is terminated (at their respective second ends) at each of the multi-fiber connectors of the second plurality of multi-fiber connectors. In order to implement an in-cable shuffle, the grouping of fibers into subsets at the second end of the cable is different to that at the first end of the cable.

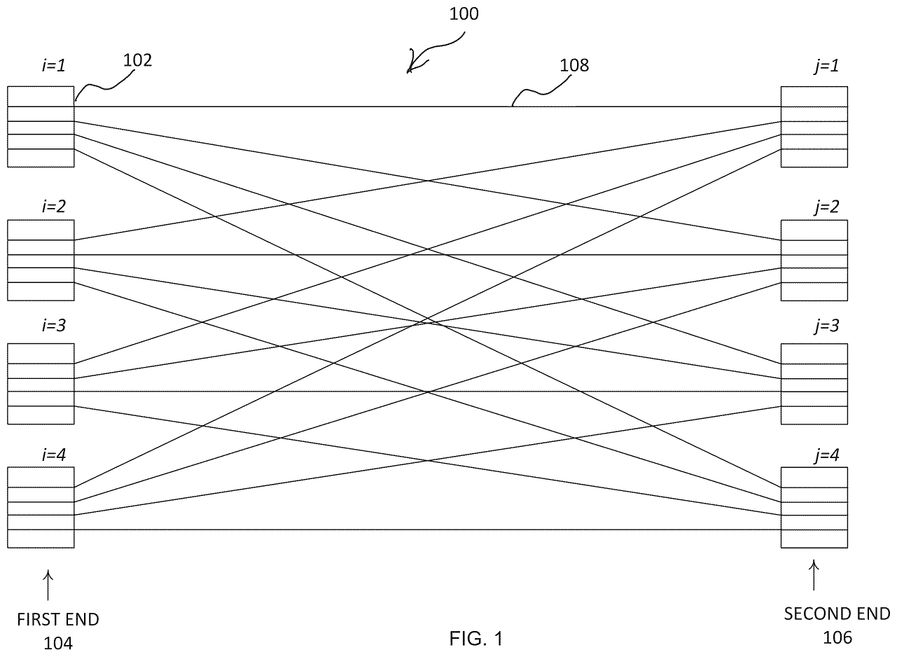

FIG. 1 shows a first example of such an in-cable fiber shuffle 100 which comprises eight 4-fiber multi-fiber connectors 102, four at each end 104, 106, with a total of sixteen fibers 108 interconnecting those multi-fiber connectors. It will be appreciated that in-cable fiber shuffles may comprise many more multi-fiber connectors and/or fibers (e.g. 16 8-fiber multi-fiber connectors and 64 fibers); however, this reduced scale is shown to reduce the complexity of the drawing.

As shown in FIG. 1, within the in-cable fiber shuffle 100, each of the fibers connected at their respective first ends to a particular one of the multi-fiber connectors at the first end 104 of the cable is connected at their respective second ends to a different one of the multi-fiber connectors at the second end 106 of the cable. In the example shown in FIG. 1, the multi-fiber connectors at the first end 104 of the cable are identified by a value i, and the multi-fiber connectors at the second end 106 of the cable are identified by a value j. Each of the first and second plurality of multi-fiber connectors comprise N multi-fiber connectors and consequently i=1−N and j=1−N, where N is an integer greater than one and in the example of FIG. 1, N=4.

A first fiber connected by its first end to multi-fiber connector i=1 is connected by its second end to multi-fiber connector j=1. A second fiber connected by its first end to multi-fiber connector i=1 is connected by its second end to multi-fiber connector j=2. A third fiber connected by its first end to multi-fiber connector i=1 is connected by its second end to multi-fiber connector j=3. A fourth fiber connected by its first end to multi-fiber connector i=1 is connected by its second end to multi-fiber connector j=4.

Similarly, a first fiber connected by its first end to multi-fiber connector i=2 is connected by its second end to multi-fiber connector j=1. A second fiber connected by its first end to multi-fiber connector i=2 is connected by its second end to multi-fiber connector j=2. A third fiber connected by its first end to multi-fiber connector i=2 is connected by its second end to multi-fiber connector j=3. A fourth fiber connected by its first end to multi-fiber connector i=2 is connected by its second end to multi-fiber connector j=4.

More generally, for an i^{th} multi-fiber connector in the first plurality of multi-fiber connectors, a j^{th} fiber, connected at its first end to said i^{th} multi-fiber connector in a j^{th} position, is connected at its second end to an i^{th} position in the j^{th} multi-fiber connector in the second plurality of multi-fiber connectors.

Each of the fibers in the in-cable fiber shuffle 100 may be referred to by an index i,j (e.g. 1,1 or 1,2, etc.) which identifies the multi-fiber connectors in which it is terminated at each end (i.e. its first end is terminated in the multi-fiber connector with the given value i and its second end is terminated in the multi-fiber connector with the given value j).

This grouping of different fibers into different subsets at each end of the table can be visualized using the following 4×4 grid of fibers with each fiber identified by its index i,j. At the first end of the cable, the fibers are grouped into subsets according to the rows of the grid (i.e. such that each subset comprises those fibers with the same value of i). At the second end of the cable, the fibers are grouped into subsets according to the columns of the grid (i.e. such that each subset comprises those fibers with the same value of j).

| | | | |
|---|---|---|---|
| 1, 1 | 1, 2 | 1, 3 | 1, 4 |
| 2, 1 | 2, 2 | 2, 3 | 2, 4 |
| 3, 1 | 3, 2 | 3, 3 | 3, 4 |
| 4, 1 | 4, 2 | 4, 3 | 4, 4 |

In the example shown in FIG. 1, there is only one fiber that connects any particular pair of multi-fiber connectors (one of which is at each end of the in-cable fiber shuffle) and as such the in-cable fiber shuffle 100 may provide a unidirectional link between the first end 104 of the cable and the second end 106 of the cable (or more particularly between the multi-fiber connectors at the first end 104 of the cable and multi-fiber connectors at the second end 106 of the cable). In such an example the multi-fiber connectors 102 at the first end 104 of the cable may be referred to as the input connectors and the multi-fiber connectors 102 at the second end 106 of the cable may be referred to as the output connectors. As the in-cable fiber shuffle is entirely passive (i.e. it does not contain any components that require electrical power) and symmetrical, the in-cable fiber shuffle can be used in either orientation and this further simplifies installation and maintenance operations.

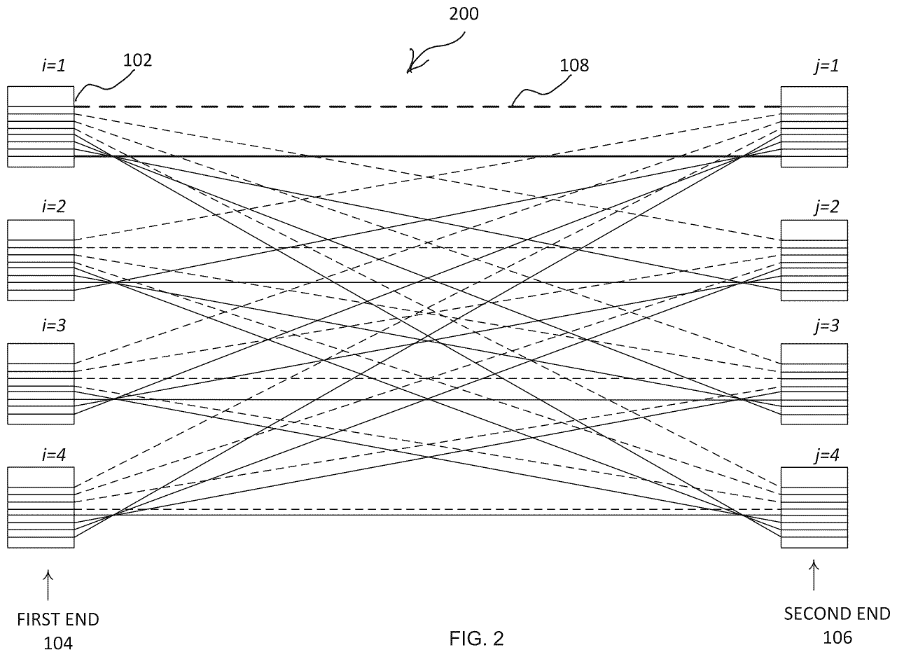

FIG. 2 shows a second example of such an in-cable fiber shuffle 200 which, like the example shown in FIG. 1, comprises eight multi-fiber connectors 102, four at each end 104, 106. However, unlike the example in FIG. 1, the connectors are 8-fiber multi-fiber connectors and there are a total of 32 fibers 108 interconnecting those multi-fiber connectors. As with the example in FIG. 1, it will be appreciated that in-cable fiber shuffles may comprise many more multi-fiber connectors and/or fibers (e.g. 16 8-fiber multi-fiber connectors and 64 fibers); however, this reduced scale is shown to reduce the complexity of the drawing.

In the example shown in FIG. 2, there is a pair of fibers that connects any particular pair of multi-fiber connectors, with one of the pair of fibers shown as a solid line and the other as a dashed line. The pair of fibers that connect the pair of multi-fiber connectors i=1 and j=1 are shown in bold in FIG. 2. As such the in-cable fiber shuffle 200 may provide a bidirectional link between the first end 104 of the cable and the second end 106 of the cable (or more particularly between the multi-fiber connectors at the first end 104 of the cable and multi-fiber connectors at the second end 106 of the cable) or may provide double the capacity of unidirectional link compared to that shown in FIG. 1.

In examples where the in-cable fiber shuffle 200 provides a bidirectional link, each multi-fiber connector operates as both an input (for one fiber in each pair) and an output (for the other fiber in each pair).

In some examples, within any multi-fiber connector 102, the fibers within a pair that connect the same two multi-fiber connectors (as represented by one solid line and one dashed line) may be positioned adjacent to each other. In other examples, however, as shown in FIG. 2, within any multi-fiber connector 102, the fibers within a pair that connect the same two multi-fiber connectors (as represented by one solid line and one dashed line) may not be positioned adjacent to each other. In the example shown, a symmetrical arrangement is used, with the two outer positions in a multi-fiber connector at the first end 104 of the cable (i=1-4) connecting to the multi-fiber connector at the second end 106 of the cable with j=1 and the center two positions in a multi-fiber connector at the first end 104 of the cable (i=1-4) connecting to the multi-fiber connector at the second end 106 of the cable with j=4. This means that each of the multi-fiber connectors (i=1-4) at the first end 104 the cable has the same mapping, as shown in the grid below:

| | | | | | | | |
|---|---|---|---|---|---|---|---|
| j = 1 | j = 2 | j = 3 | j = 4 | j = 4 | j = 3 | j = 2 | j = 1 |

Similarly, each of the multi-fiber connectors (i=1-4) at the second end 106 the cable has the same mapping, as shown in the grid below:

| | | | | | | | |
|---|---|---|---|---|---|---|---|
| i = 1 | i = 2 | i = 3 | i = 4 | i = 4 | i = 3 | i = 2 | i = 1 |

Both the use of the same arrangement for each multi-fiber connector and a symmetrical arrangement within each multi-fiber connector, simplifies installation and maintenance operations (e.g. since an in-cable fiber shuffle can be inserted in either orientation and there is no difference to its functionality).

More generically, for an i^{th} multi-fiber connector in the first plurality of multi-fiber connectors, a j^{th} pair of fibers comprises one fiber connected at its first end to said i^{th} multi-fiber connector in a j^{th} position and connected at its second end to an i^{th} position in the j^{th} multi-fiber connector in the second plurality of multi-fiber connectors and a second fiber connected at its first end to said i^{th} multi-fiber connector in a (N+1−j)^{th} position and connected at its second end to a (N+1−i)^{th} position in the j^{th} multi-fiber connector in the second plurality of multi-fiber connectors.

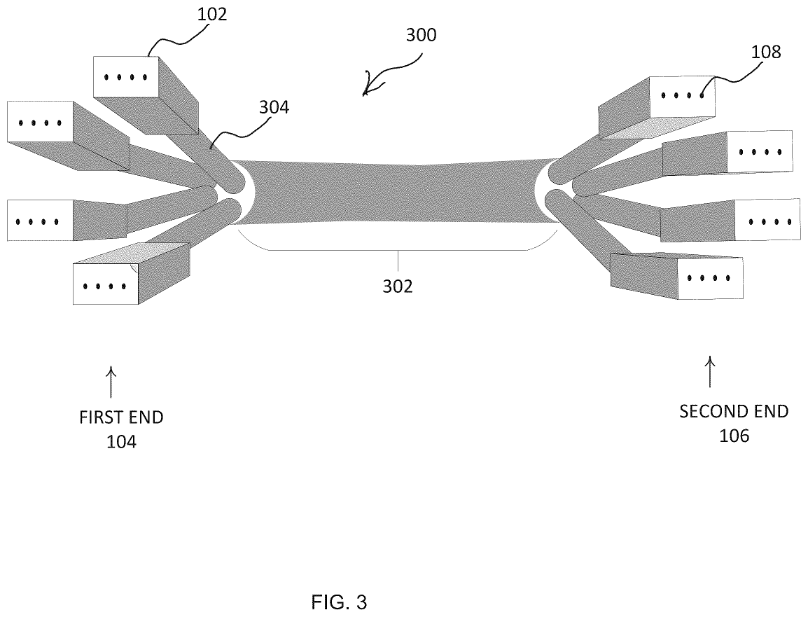

Whilst not shown in FIGS. 1 and 2, the fibers in the in-cable fibre shuffle may be protected by sleeving, to increase durability and simplify installation and maintenance operations. This is shown in FIG. 3 which shows a perspective view of a third example in-cable fiber shuffle 300. As with the example in FIG. 1, there are eight multi-fiber connectors 102, four at each end 104, 106 of the cable, and each multi-fiber connector 102 terminates four fibers 108. With the protective sleeving in place, there is a center portion of the cable 302 which contains all 16 fibers and four breakout portions 304 at each end, one per multi-fiber connector, each containing four fibers. Each breakout portion 304 of the cable contains the subset of fibers that are terminated at the respective multi-fiber connector.

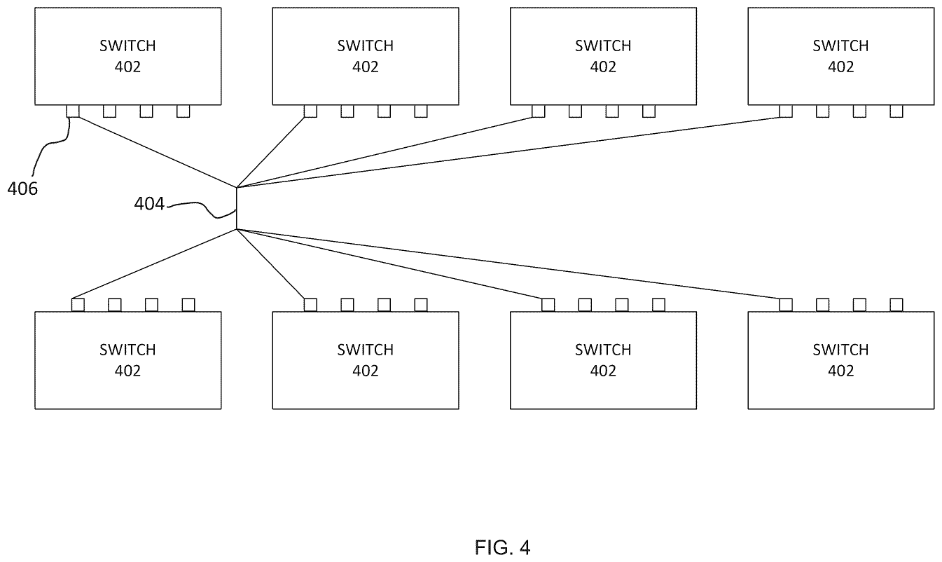

As described above, the in-cable fiber shuffle described herein is particularly suited to use in data centers that perform AI tasks. FIG. 4 shows a schematic diagram of a portion of a data center that comprises a plurality of switches 402 interconnected by a single in-cable fiber shuffle 404 as described herein. Each of the switches 402 comprise four ports 406 and in the example shown, the in-cable fiber shuffle 404 interconnects the first port of each of the switches 402.

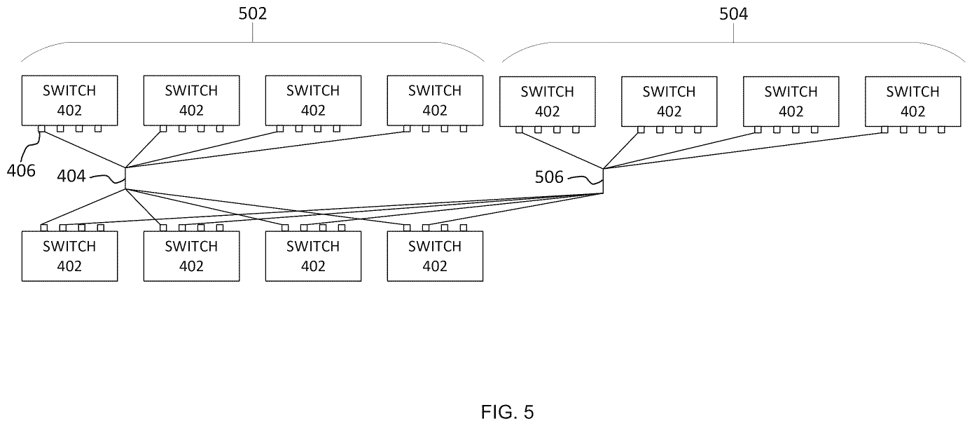

FIG. 5 shows how use of the in-cable fiber shuffles as described herein can be used to increase the radix within a data center. In the example shown in FIG. 5 there are eight switches 402 in the upper tier, four in a first rail 502 and four in a second rail 504. A separate in-cable fiber shuffle 404, 506 connects the four switches 402 in the lower tier to each of the rails in the tier above. The first in-cable fiber shuffle 404 connects port 1 of each switch in the lower tier to port 1 of each switch in the first rail 502 (as in FIG. 4) and the second in-cable fiber shuffle 506 connects port 2 of each switch in the lower tier to a port (port 1 in the example shown) of each of the switches 402 in the second rail 504. Each of the in-cable fiber shuffles is identical (i.e. it performs an identical shuffling operation between the multi-fiber connectors at each of its ends).

By extension of the principles shown in FIG. 5, using four in-cable fiber shuffles (each one connecting a different port on the switches in the lower tier to switches in a different rail) as described herein enables the radix to be increased by a factor of four, whilst keeping the cable management, number of cables and overall losses down compared to use of multiple cables and patch panels as in conventional data center topologies. Additionally it does not require the number of ports to be increased, which reduces the size and power requirements.

As described above, an in-cable fiber shuffle may comprise more multi-fiber connectors than those shown in FIGS. 1-5. In an example that comprises 16 multi-fiber connectors (eight at each end), this enables the radix to be increased by a factor of eight. Each of the 16 multi-fiber connectors may be an 8-fiber multi-fiber connector where there is a single fiber between each pair of multi-fiber connectors, one at each end of the in-cable fiber shuffle (e.g. in an extension of that shown in FIG. 1) or a 16-fiber multi-fiber connector where there is a pair of fibers between each pair of multi-fiber connectors, one at each end of the in-cable fiber shuffle (e.g. in an extension of that shown in FIG. 2).

Furthermore, whereas failure of a patch panel within a conventional topology may result in total loss of connectivity within the data center, the use of multiple independent in-cable fiber shuffles, as shown in FIG. 5, means that failure of one in-cable fiber shuffle only impacts traffic flowing through switches in a single rail and the faulty in-cable fiber shuffle can be replaced without affecting traffic flowing through switches in other rails (and hence through other in-cable fiber shuffles).

In the data centers shown in FIGS. 4 and 5, which are designed for AI tasks, there is direct lane matching between the GPUs performing the AI tasks, the routing ASICs within the switches and the data center optics (including the electro-optics within the switches and the in-cable fiber shuffles). This means that if the GPUs operate on 100G lanes, these are matched in size to the physical transport lanes between the switches. Each multi-fiber connector in the in-cable fiber shuffle handles one 100G lane per fiber, so 4×100G lanes in the examples shown in FIGS. 1-5. Operating at lane speed avoids the congestion issues that might otherwise arise if lanes were multiplexed and/or demultiplexed within the switches.

The in-cable fiber shuffles described herein may be fabricated by manipulating the plurality of optical fibers into the correct configuration (e.g. as described above) prior to attaching the multi-fiber connectors (a process referred to as ‘connectorization’). As described above, each length of optical fiber that connects one multi-fiber connector to another multi-fiber connector is a continuous length, without any splices, joins or junctions between the two connectors.

Although the present examples of in-cable fiber shuffles are described and illustrated herein as being implemented in a data center that performs AI tasks (e.g. training and inference tasks), the in-cable fiber shuffles are suitable for application in a variety of different types of data centers or other applications.

Alternatively or in addition to the other examples described herein, examples include any combination of the following:
Clause A: An in-cable fiber shuffle (100, 200, 300, 404, 506) having a first end (104) and a second end (106), the in-cable fiber shuffle comprising: a first plurality of optical fibers (108), each optical fiber comprising a continuous length of fiber from a first end to a second end; a first plurality of multi-fiber connectors (102) at the first end (104) of the in-cable fiber shuffle; and a second plurality of multi-fiber connectors (102) at the second end (106) of the in-cable fiber shuffle, wherein each one of the first plurality of multi-fiber connectors are connected to the first ends of a different, non-overlapping subset of the first plurality of optical fibers and each optical fiber connected to a respective one of the first plurality of multi-fiber connectors is connected at its second end to a different one of the second plurality of multi-fiber connectors.
Clause B: An in-cable fiber shuffle according to clause A, wherein each of the first and second pluralities of multi-fiber connectors comprise N multi-fiber connectors, and wherein, for an i^{th} multi-fiber connector in the first plurality of multi-fiber connectors, a j^{th} fiber, connected at its first end to said i^{th} multi-fiber connector, is connected at its second end to the j^{th} multi-fiber connector in the second plurality of multi-fiber connectors, where i=1−N and j=1−N.
Clause C: An in-cable fiber shuffle according to clause B, wherein for each of the first plurality of multi-fiber connectors, the first ends of the subset of the first plurality of optical fibers are connected in a sequence according to the multi-fiber connector of the second plurality of multi-fiber connectors to which their respective second ends are connected.
Clause D: An in-cable fiber shuffle according to clause B or C, wherein for an i^{th} multi-fiber connector in the first plurality of multi-fiber connectors, a j^{th} fiber, connected at its first end to said i^{th} multi-fiber connector in a j^{th} position, is connected at its second end to an i^{th} position in the j^{th} multi-fiber connector in the second plurality of multi-fiber connectors.
Clause E: An in-cable fiber shuffle according to any of clauses A-D, further comprising: a second plurality of optical fibers (108), each optical fiber of the second plurality of optical fibers comprising a continuous length of fiber from a first end to a second end, wherein each one of the first plurality of multi-fiber connectors are connected to the first ends of a different, non-overlapping subset of pairs of fibers, each pair of fibers comprising one fiber from the first plurality of optical fibers and one fiber from the second plurality of optical fibers, and for each pair of fibers, the fiber of the second plurality of optical fibers is connected at its second end to a same one of the second plurality of multi-fiber connectors as the fiber of the first plurality of optical fibers.
Clause F: An in-cable fiber shuffle according to clause E, wherein each of the first and second pluralities of multi-fiber connectors comprise N multi-fiber connectors, and wherein, for an i^{th} multi-fiber connector in the first plurality of multi-fiber connectors, a j^{th} pair of fibers, connected at its first ends to said i^{th} multi-fiber connector, is connected at its second ends to the j^{th} multi-fiber connector in the second plurality of multi-fiber connectors, where i=1−N and j=1−N.
Clause G: An in-cable fiber shuffle according to clause F, wherein for an i^{th} multi-fiber connector in the first plurality of multi-fiber connectors, a j^{th} pair of fibers, comprises one fiber connected at its first end to said i^{th} multi-fiber connector in a j^{th} position and connected at its second end to an i^{th} position in the j^{th} multi-fiber connector in the second plurality of multi-fiber connectors and a second fiber connected at its first end to said i^{th} multi-fiber connector in a (N+1−j)^{th} position and connected at its second end to a (N+1−i)^{th} position in the j^{th} multi-fiber connector in the second plurality of multi-fiber connectors.
Clause H: A data center comprising: a first plurality of optical switches (402) in a first tier; a second plurality of optical switches (402) in a second, adjacent, tier; and a first in-cable fiber shuffle having a first end (104) and a second end (106), the in-cable fiber shuffle comprising: a first plurality of optical fibers (108), each optical fiber comprising a continuous length of fiber from a first end to a second end; a first plurality of multi-fiber connectors (102) at the first end (104) of the in-cable fiber shuffle; and a second plurality of multi-fiber connectors (102) at the second end (106) of the in-cable fiber shuffle, wherein each one of the first plurality of multi-fiber connectors are connected to the first ends of a different, non-overlapping subset of the first plurality of optical fibers and each optical fiber connected to a respective one of the first plurality of multi-fiber connectors is connected at its second end to a different one of the second plurality of multi-fiber connectors, wherein each of the first plurality of multi-fiber connectors in the first in-cable fiber shuffle is connected to a different one of the first plurality of optical switches and each of the second plurality of multi-fiber connectors in the first in-cable fiber shuffle is connected to a different one of the second plurality of optical switches.
Clause I: The data center according to clause H, further comprising: a third plurality of optical switches (402) in the first tier; and a second in-cable fiber shuffle having a first end (104) and a second end (106), the second in-cable fiber shuffle comprising: a first plurality of optical fibers (108), each optical fiber comprising a continuous length of fiber from a first end to a second end; a first plurality of multi-fiber connectors (102) at the first end (104) of the in-cable fiber shuffle; and a second plurality of multi-fiber connectors (102) at the second end (106) of the in-cable fiber shuffle, wherein each one of the first plurality of multi-fiber connectors are connected to the first ends of a different, non-overlapping subset of the first plurality of optical fibers and each optical fiber connected to a respective one of the first plurality of multi-fiber connectors is connected at its second end to a different one of the second plurality of multi-fiber connectors, wherein each of the first plurality of multi-fiber connectors in the second in-cable fiber shuffle is connected to a different one of the first plurality of optical switches and each of the second plurality of multi-fiber connectors in the second in-cable fiber shuffle is connected to a different one of the third plurality of optical switches.
Clause J: The data center according to clause H or I, wherein each of the first and second pluralities of multi-fiber connectors comprise N multi-fiber connectors, and wherein, for an i^{th} multi-fiber connector in the first plurality of multi-fiber connectors, a j^{th} fiber, connected at its first end to said i^{th} multi-fiber connector, is connected at its second end to the j^{th} multi-fiber connector in the second plurality of multi-fiber connectors, where i=1−N and j=1−N.
Clause K: The data center according to any of clauses H-J, wherein for each of the first plurality of multi-fiber connectors, the first ends of the subset of the first plurality of optical fibers are connected in a sequence according to the multi-fiber connector of the second plurality of multi-fiber connectors to which their respective second ends are connected.
Clause L: The data center according to clause K, wherein for an i^{th} multi-fiber connector in the first plurality of multi-fiber connectors, a j^{th} fiber, connected at its first end to said i^{th} multi-fiber connector in a j^{th} position, is connected at its second end to an i^{th} position in the j^{th} multi-fiber connector in the second plurality of multi-fiber connectors.
Clause M; The data center according to any of clauses H-L, further comprising: a second plurality of optical fibers (108), each optical fiber of the second plurality of optical fibers comprising a continuous length of fiber from a first end to a second end, wherein each one of the first plurality of multi-fiber connectors are connected to the first ends of a different, non-overlapping subset of pairs of fibers, each pair of fibers comprising one fiber from the first plurality of optical fibers and one fiber from the second plurality of optical fibers, and for each pair of fibers, the fiber of the second plurality of optical fibers is connected at its second end to a same one of the second plurality of multi-fiber connectors as the fiber of the first plurality of optical fibers.
Clause N: The data center according to any of clauses H-M, wherein each of the first and second pluralities of multi-fiber connectors comprise N multi-fiber connectors, and wherein, for an i^{th} multi-fiber connector in the first plurality of multi-fiber connectors, a j^{th} pair of fibers, connected at its first ends to said i^{th} multi-fiber connector, is connected at its second ends to the j^{th} multi-fiber connector in the second plurality of multi-fiber connectors, where i=1−N and j=1−N.
Clause O: The data center according to clause N, wherein for an i^{th} multi-fiber connector in the first plurality of multi-fiber connectors, a j^{th} pair of fibers, comprises one fiber connected at its first end to said i^{th} multi-fiber connector in a j^{th} position and connected at its second end to an i^{th} position in the j^{th} multi-fiber connector in the second plurality of multi-fiber connectors and a second fiber connected at its first end to said i^{th} multi-fiber connector in a (N+1−j)^{th} position and connected at its second end to a (N+1−i)^{th} position in the j^{th} multi-fiber connector in the second plurality of multi-fiber connectors.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

Additionally, as used in this disclosure, phrases of the form “at least one of an A, a B, or a C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

What is claimed is:

1. An in-cable fiber shuffle having a first end and a second end, the in-cable fiber shuffle comprising:
a first plurality of optical fibers, each optical fiber comprising a continuous length of fiber from a first end to a second end;
a first plurality of multi-fiber connectors at the first end of the in-cable fiber shuffle; and
a second plurality of multi-fiber connectors at the second end of the in-cable fiber shuffle,
wherein each one of the first plurality of multi-fiber connectors are connected to the first ends of a different, non-overlapping subset of the first plurality of optical fibers and each optical fiber connected to a respective one of the first plurality of multi-fiber connectors is connected at its second end to a different one of the second plurality of multi-fiber connectors.

2. An in-cable fiber shuffle according to claim 1, wherein each of the first and second pluralities of multi-fiber connectors comprise N multi-fiber connectors, and wherein, for an i^{th} multi-fiber connector in the first plurality of multi-fiber connectors, a j^{th} fiber, connected at its first end to said i^{th} multi-fiber connector, is connected at its second end to the j^{th} multi-fiber connector in the second plurality of multi-fiber connectors, where i=1−N and j=1−N.

3. An in-cable fiber shuffle according to claim 2, wherein for each of the first plurality of multi-fiber connectors, the first ends of the subset of the first plurality of optical fibers are connected in a sequence according to the multi-fiber connector of the second plurality of multi-fiber connectors to which their respective second ends are connected.

4. An in-cable fiber shuffle according to claim 2, wherein for an i^{th} multi-fiber connector in the first plurality of multi-fiber connectors, a j^{th} fiber, connected at its first end to said i^{th} multi-fiber connector in a j^{th} position, is connected at its second end to an i^{th} position in the j^{th} multi-fiber connector in the second plurality of multi-fiber connectors.

5. An in-cable fiber shuffle according to claim 1, further comprising:
a second plurality of optical fibers, each optical fiber of the second plurality of optical fibers comprising a continuous length of fiber from a first end to a second end,
wherein each one of the first plurality of multi-fiber connectors are connected to the first ends of a different, non-overlapping subset of pairs of fibers, each pair of fibers comprising one fiber from the first plurality of optical fibers and one fiber from the second plurality of optical fibers, and for each pair of fibers, the fiber of the second plurality of optical fibers is connected at its second end to a same one of the second plurality of multi-fiber connectors as the fiber of the first plurality of optical fibers.

6. An in-cable fiber shuffle according to claim 5, wherein each of the first and second pluralities of multi-fiber connectors comprise N multi-fiber connectors, and wherein, for an i^{th} multi-fiber connector in the first plurality of multi-fiber connectors, a j^{th} pair of fibers, connected at its first ends to said i^{th} multi-fiber connector, is connected at its second ends to the j^{th} multi-fiber connector in the second plurality of multi-fiber connectors, where i=1−N and j=1−N.

7. An in-cable fiber shuffle according to claim 6, wherein for an i^{th} multi-fiber connector in the first plurality of multi-fiber connectors, a j^{th} pair of fibers, comprises one fiber connected at its first end to said i^{th} multi-fiber connector in a j^{th} position and connected at its second end to an i^{th} position in the j^{th} multi-fiber connector in the second plurality of multi-fiber connectors and a second fiber connected at its first end to said i^{th} multi-fiber connector in a (N+1−j)^{th} position and connected at its second end to a (N+1−i)^{th} position in the j^{th} multi-fiber connector in the second plurality of multi-fiber connectors.

8. A data center comprising:
a first plurality of optical switches in a first tier;
a second plurality of optical switches in a second, adjacent, tier; and
a first in-cable fiber shuffle having a first end and a second end, the in-cable fiber shuffle comprising:
a first plurality of optical fibers, each optical fiber comprising a continuous length of fiber from a first end to a second end;
a first plurality of multi-fiber connectors at the first end of the in-cable fiber shuffle; and
a second plurality of multi-fiber connectors at the second end of the in-cable fiber shuffle,
wherein each one of the first plurality of multi-fiber connectors are connected to the first ends of a different, non-overlapping subset of the first plurality of optical fibers and each optical fiber connected to a respective one of the first plurality of multi-fiber connectors is connected at its second end to a different one of the second plurality of multi-fiber connectors,
wherein each of the first plurality of multi-fiber connectors in the first in-cable fiber shuffle is connected to a different one of the first plurality of optical switches and each of the second plurality of multi-fiber connectors in the first in-cable fiber shuffle is connected to a different one of the second plurality of optical switches.

9. The data center according to claim 8, further comprising:
a third plurality of optical switches in the first tier; and
a second in-cable fiber shuffle having a first end and a second end, the second in-cable fiber shuffle comprising:
a first plurality of optical fibers, each optical fiber comprising a continuous length of fiber from a first end to a second end;
a first plurality of multi-fiber connectors at the first end of the in-cable fiber shuffle; and
a second plurality of multi-fiber connectors at the second end of the in-cable fiber shuffle,
wherein each one of the first plurality of multi-fiber connectors are connected to the first ends of a different, non-overlapping subset of the first plurality of optical fibers and each optical fiber connected to a respective one of the first plurality of multi-fiber connectors is connected at its second end to a different one of the second plurality of multi-fiber connectors,
wherein each of the first plurality of multi-fiber connectors in the second in-cable fiber shuffle is connected to a different one of the first plurality of optical switches and each of the second plurality of multi-fiber connectors in the second in-cable fiber shuffle is connected to a different one of the third plurality of optical switches.

10. The data center according to claim 8, wherein each of the first and second pluralities of multi-fiber connectors comprise N multi-fiber connectors, and wherein, for an i^{th} multi-fiber connector in the first plurality of multi-fiber connectors, a j^{th} fiber, connected at its first end to said i^{th} multi-fiber connector, is connected at its second end to the j^{th} multi-fiber connector in the second plurality of multi-fiber connectors, where i=1−N and j=1−N.

11. The data center according to claim 10, wherein for each of the first plurality of multi-fiber connectors, the first ends of the subset of the first plurality of optical fibers are connected in a sequence according to the multi-fiber connector of the second plurality of multi-fiber connectors to which their respective second ends are connected.

12. The data center according to claim 10, wherein for an i^{th} multi-fiber connector in the first plurality of multi-fiber connectors, a j^{th} fiber, connected at its first end to said i^{th} multi-fiber connector in a j^{th} position, is connected at its second end to an i^{th} position in the j^{th} multi-fiber connector in the second plurality of multi-fiber connectors.

13. The data center according to claim 8, further comprising:
a second plurality of optical fibers, each optical fiber of the second plurality of optical fibers comprising a continuous length of fiber from a first end to a second end,
wherein each one of the first plurality of multi-fiber connectors are connected to the first ends of a different, non-overlapping subset of pairs of fibers, each pair of fibers comprising one fiber from the first plurality of optical fibers and one fiber from the second plurality of optical fibers, and for each pair of fibers, the fiber of the second plurality of optical fibers is connected at its second end to a same one of the second plurality of multi-fiber connectors as the fiber of the first plurality of optical fibers.

14. The data center according to claim 13, wherein each of the first and second pluralities of multi-fiber connectors comprise N multi-fiber connectors, and wherein, for an i^{th} multi-fiber connector in the first plurality of multi-fiber connectors, a j^{th} pair of fibers, connected at its first ends to said i^{th} multi-fiber connector, is connected at its second ends to the j^{th} multi-fiber connector in the second plurality of multi-fiber connectors, where i=1−N and j=1−N.

15. The data center according to claim 14, wherein for an i^{th} multi-fiber connector in the first plurality of multi-fiber connectors, a j^{th} pair of fibers, comprises one fiber connected at its first end to said i^{th} multi-fiber connector in a j^{th} position and connected at its second end to an i^{th} position in the j^{th} multi-fiber connector in the second plurality of multi-fiber connectors and a second fiber connected at its first end to said i^{th} multi-fiber connector in a (N+1−j)^{th} position and connected at its second end to a (N+1−i)^{th} position in the j^{th} multi-fiber connector in the second plurality of multi-fiber connectors.
